(19) United States
(12) Patent Application Publication
(10) Pub. No.: US 2026/0203059 A1
(43) Pub. Date: Jul. 16, 2026

(54) EFFICIENT RUNTIME DESCRIPTOR FILLING FOR DYNAMIC NETWORK

(71) Applicant: Mediatek Inc., Hsinchu (TW)

(72) Inventors: Chia-Chen Yen, Hsinchu (TW); Sheng-Jie Shu, Hsinchu (TW); Cheng-Hsin Shen, Hsinchu (TW)

(21) Appl. No.: 19/023,605

(22) Filed: Jan. 16, 2025

(51) Int. Cl. G06F 9/30; G06F 12/02; G06F 12/0811

(52) U.S. Cl. CPC G06F 9/30047; G06F 12/0292; G06F 12/0811

(57) ABSTRACT

In an aspect of the disclosure, a method, a computer-readable medium, and an apparatus are provided. The method may be executed by a computing device. The computing device receives a task to be processed. The computing device extracts an argument and an address from the task. The computing device retrieves a descriptor corresponding to the argument from a cache, based on the argument, at a runtime stage of an execution of the task. The computing device performs the task, based on the descriptor and the address.

### BACKGROUND

### Field

The present disclosure relates generally to neural networks, and more particularly, to techniques of efficient runtime descriptor filling for dynamic network.

### Background

The statements in this section merely provide background information related to the present disclosure and may not constitute prior art.

Deep learning has gained wide acceptance for its superior performance in the fields of computer vision, speech recognition, natural language processing, bioinformatics, and the like. Deep learning is a branch of machine learning that uses artificial neural networks. Neural networks (NNs) can learn from various examples of a certain task during a process called training. After learning, the task can be performed on new data during a process called inference. An NN inference can have a huge amount of weights and activations and have to be stored in a sufficiently large memory, such as a dynamic random access memory (DRAM).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be executed by a computing device. The computing device receives a task to be processed. The computing device extracts an argument and an address from the task. The computing device retrieves a descriptor corresponding to the argument from a cache, based on the argument, at a runtime stage of an execution of the task. The computing device performs the task, based on the descriptor and the address.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a system architecture for efficient runtime descriptor filling in dynamic neural networks.

FIG. 2 is a block diagram illustrating an example of an NN processing unit that includes a fixed-point circuit.

FIG. 3 is a block diagram illustrating an example of an NN processing unit that includes a floating-point circuit.

FIG. 4(A) is a diagram illustrating a dynamic neural network for image classification.

FIG. 4(B) is a diagram illustrating the utilization of computational resources against the number of input samples for the dynamic neural network.

FIG. 5 is a diagram illustrating the utilization of DMA in processing images.

FIG. 6(A) is a diagram illustrating the processing structure for isolating arguments and addresses from the task.

FIG. 6(B) is a diagram illustrating an example process for tasks.

FIG. 7(A) is a diagram illustrating two example scenarios.

FIG. 7(B) is a diagram illustrating a example process for scenario configuration and switch.

FIG. 8 is a flow chart of a process for runtime descriptor management.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computing systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

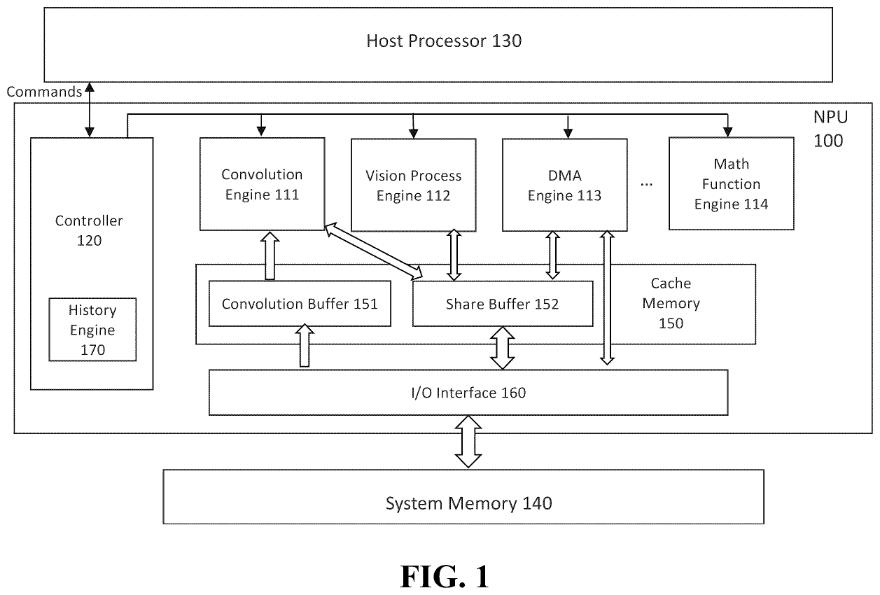

FIG. 1 is a diagram illustrating a system architecture for efficient runtime descriptor filling in dynamic neural networks. The system includes a neural processing unit (NPU) 100 coupled to a host processor 130 and a system memory 140. The NPU 100 is designed to perform neural network computations efficiently, utilizing various specialized engines and memory components. The host processor 130 may be a CPU, a GPU, a DSP, a media processor, or another general-purpose and/or special-purpose processing circuitry.

The NPU 100 incorporates multiple engines, each optimized for specific neural network operations. Each engine may include hardware circuits, such as multipliers, adders, and accumulators, for performing mathematical computations. These engines include a convolution engine 111 for performing convolution operations, an vision process engine 112 for executing vision process, a direct memory access (DMA) engine 113 for direct memory access, and a math function engine 114 for computing various mathematical functions. The NPU 100 may include additional engines not shown in the figure to support a wider range of neural network operations.

Neural network processing includes a series of layers. At each layer, one of the engines performs operations on an input feature map to produce an output feature map. The output feature map of a first engine may become the input feature map of a second engine. Each of these feature maps, which include input feature maps and output feature maps, is a multi-dimensional array, also referred to as a tensor. For example, a feature map may have three dimensions, including width, height, and depth.

Furthermore, the NPU 100 includes a cache memory 150, which includes a convolution buffer 151 and a share buffer 152. The convolution buffer 151 is dedicated to storing input data and filter weights for the convolution engine 111, while the share buffer 152 stores intermediate input and output data accessible by all engines 111-114. These buffers may be implemented using Static Random Access Memory (SRAM) or other suitable memory technologies to provide fast data access for the engines.

The NPU 100 also includes a controller 120, which receives commands from the host processor 130 and dispatches them to the appropriate engines 111-114. The controller 120 also implements descriptor caching and preloading mechanisms described infra in this disclosure. The controller 120 may manage the isolation of arguments and addresses in tasks, enabling efficient descriptor lookup and reuse.

An I/O interface 160 facilitates data transfer between the NPU 100 and the system memory 140. This interface is used to load input data and store output results. The controller 120 implements intelligent tiling schemes and tile traversal strategies to optimize data transfer and processing efficiency.

The controller 120 may include a history engine 170, which supports the cache warm-up mechanism described in the invention. It manages the storage and loading of reusable descriptors based on different scenarios or computational contexts. This engine works to preload frequently used descriptors into the cache, reducing descriptor filling time during runtime.

The system architecture in FIG. 1 supports features described infra in this disclosure. The isolation of arguments and addresses in tasks may be implemented within the controller 120, which manages the descriptor cache and lookup process. An cache warm-up mechanism may be realized through the collaboration of the controller 120 and cache memory 150. This architecture enables efficient runtime descriptor filling for dynamic neural networks, addressing the performance issues associated with frequent descriptor generation in dynamic computational graphs.

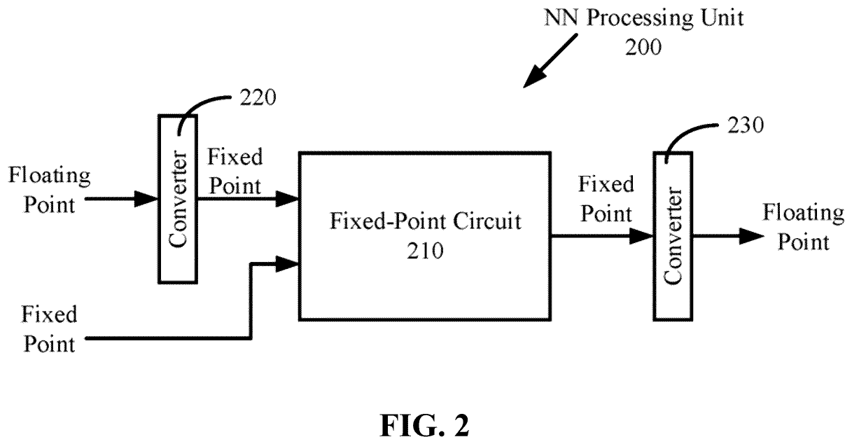

FIG. 2 is a block diagram illustrating an NN processing unit 200 that incorporates a fixed-point circuit 210. This processing unit is designed to efficiently handle neural network computations using fixed-point arithmetic, while also supporting hybrid-precision operations. The NN processing unit 200 includes three main components: an input converter 220, a fixed-point circuit 210, and an output converter 230.

The fixed-point circuit 210 forms the core of the NN processing unit 200 and is specifically optimized for fixed-point computations. This circuit is capable of performing various neural network operations, such as convolutions, matrix multiplications, and element-wise operations, using fixed-point arithmetic. The use of fixed-point representation allows for faster computations and reduced hardware complexity compared to floating-point operations.

The input converter 220 is connected to the input of the fixed-point circuit 210. This converter enables hybrid-precision computing within the NN processing unit 200. When the processing unit receives input operands in different number representations, such as floating-point and fixed-point, the input converter 220 is responsible for converting the floating-point operands to fixed-point format. This conversion allows the fixed-point circuit 210 to process all inputs uniformly.

For instance, when the NN processing unit 200 receives a first input operand in floating-point format and a second input operand in fixed-point format for a particular neural network layer, the input converter 220 may convert the floating-point operand to fixed-point representation. Subsequently, the fixed-point circuit 210 can perform its computations on both operands using fixed-point arithmetic.

The output converter 230 is connected to the output of the fixed-point circuit 210. Depending on the requirements of the subsequent neural network layer or the final output format needed, the output converter 230 can either be bypassed or used to convert the fixed-point output back to floating-point representation.

Further, the NN processing unit 200 is also capable of performing fixed-point tensor operations without any input conversion when all input operands are already in fixed-point format. This feature allows for efficient processing of neural networks that are designed to work entirely with fixed-point arithmetic.

Further, the NN processing unit 200 may be integrated as part of the NPU 100, potentially forming a component of one or more of the specialized engines (111-114). The fixed-point circuit 210 may be implemented within these engines to perform specific neural network operations efficiently.

Furthermore, the NN processing unit 200 may benefit from the descriptor caching and preloading mechanisms described in the invention disclosure. The controller 120 from FIG. 1 may manage the operation of the NN processing unit 200, including the scheduling of conversions and computations. The cache memory 150 may be utilized to store intermediate results or conversion parameters needed by the input converter 220 and output converter 230.

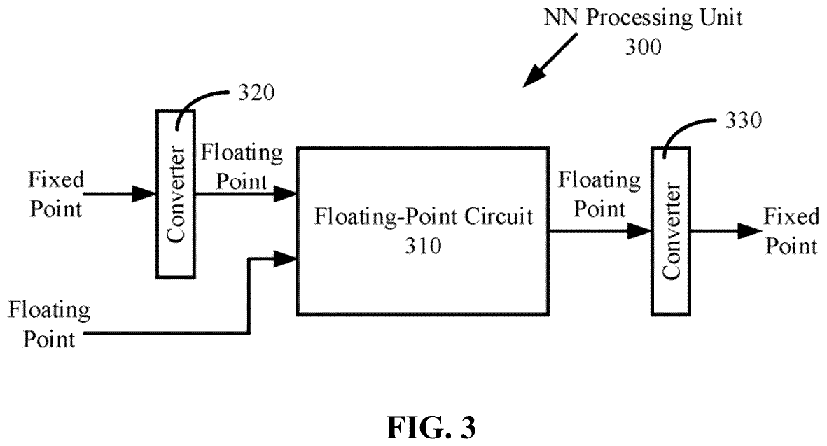

FIG. 3 is a block diagram illustrating an NN processing unit 300 that incorporates a floating-point circuit 310. This processing unit is designed to efficiently handle neural network computations using floating-point arithmetic, while also supporting hybrid-precision operations. The NN processing unit 300 includes three main components: an input converter 320, a floating-point circuit 310, and an output converter 330.

The floating-point circuit 310 forms the core of the NN processing unit 300 and is specifically optimized for floating-point computations. This circuit is capable of performing various neural network operations, such as convolutions, matrix multiplications, and element-wise operations, using floating-point arithmetic. The use of floating-point representation allows for higher precision computations compared to fixed-point operations, which can be beneficial for certain neural network architectures or tasks that require higher numerical accuracy.

The input converter 320 is connected to the input of the floating-point circuit 310. This converter enables hybrid-precision computing within the NN processing unit 300. When the processing unit receives input operands in different number representations, such as fixed-point and floating-point, the input converter 320 is responsible for converting the fixed-point operands to floating-point format. This conversion allows the floating-point circuit 310 to process all inputs uniformly.

For instance, when the NN processing unit 300 receives a first input operand in fixed-point format and a second input operand in floating-point format for a particular neural network layer, the input converter 320 may convert the fixed-point operand to floating-point representation. Subsequently, the floating-point circuit 310 can perform its computations on both operands using floating-point arithmetic.

The output converter 330 is connected to the output of the floating-point circuit 310. Depending on the requirements of the subsequent neural network layer or the final output format needed, the output converter 330 can either be bypassed or used to convert the floating-point output back to fixed-point representation.

The NN processing unit 300 is also capable of performing floating-point tensor operations without any input conversion when all input operands are already in floating-point format. This feature allows for efficient processing of neural networks that are designed to work entirely with floating-point arithmetic.

The NN processing unit 300 may be integrated as part of the NPU 100, potentially forming a component of one or more of the specialized engines (111-114). The floating-point circuit 310 may be implemented within these engines to perform specific neural network operations efficiently.

Furthermore, the NN processing unit 300 may benefit from the descriptor caching and preloading mechanisms described in the invention disclosure. The controller 120 from FIG. 1 may manage the operation of the NN processing unit 300, including the scheduling of conversions and computations. The cache memory 150 may be utilized to store intermediate results or conversion parameters needed by the input converter 320 and output converter 330.

The dynamic neural network architecture, which is the focus of this invention, represents a significant advancement in deep learning, particularly in the realm of computer vision tasks. Unlike static models that utilize fixed computational graphs and parameters during inference, dynamic networks adapt their structures or parameters based on input complexity. This adaptability offers notable advantages in terms of accuracy, computational efficiency, and responsiveness to diverse inputs.

In static models, the computational graphs and parameters remain constant, regardless of input complexity or available computational resources. In contrast, dynamic networks intelligently allocate resources, employing fewer computations for simpler samples or inputs with reduced spatial or temporal information. This approach allows dynamic networks to achieve competitive performance while significantly reducing the number of floating-point operations per second (FLOPs) compared to static models.

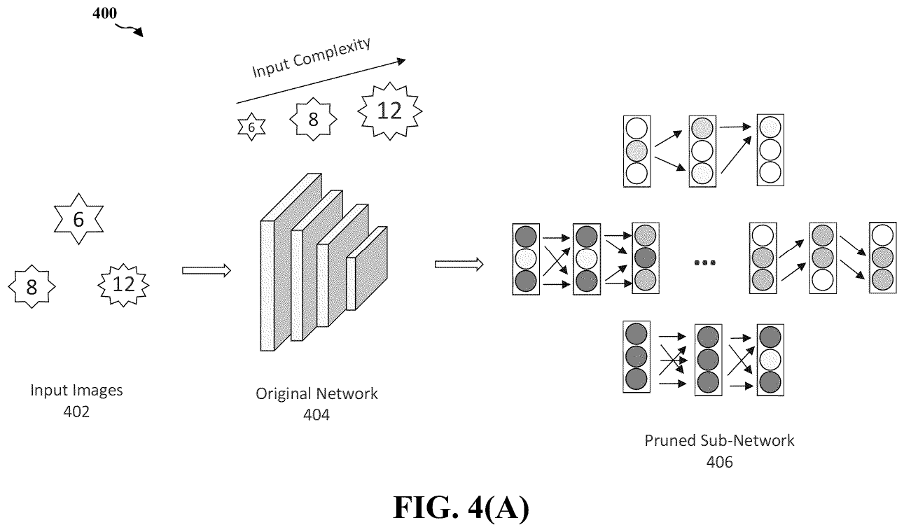

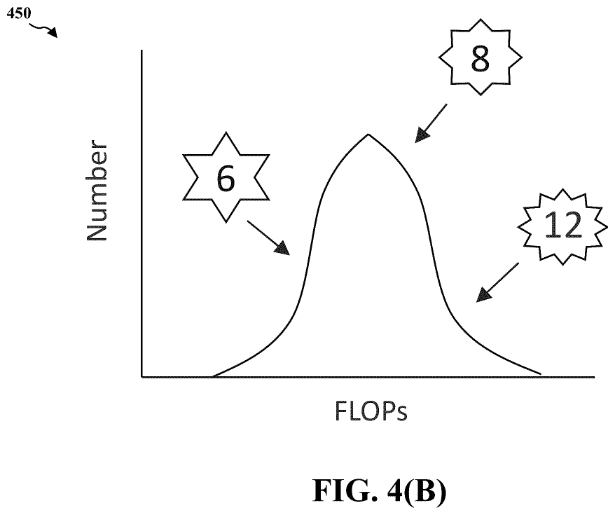

FIG. 4(A) is a diagram 400 illustrating a dynamic neural network for image classification. The diagram shows the adaptability of dynamic networks compared to static models in processing input images. As shown in FIG. 4(A), when images 402 are input into an original network 404 and pruned sub-networks 406, which may be convolutional neural networks (CNNs), the path traversed by the data within these networks differs significantly between static and dynamic models.

In static models, the computational path remains fixed regardless of the input complexity. However, in dynamic models, the path varies adaptively, responding to both the input's complexity and the current computational budgets. FIG. 4(A) also illustrates the range of input complexities and computational budgets that the dynamic network can handle.

The input images 402 shown in FIG. 4(A) represent a diverse set of samples, including animals, vehicles, and natural scenes. These images are processed by the original network 404, which may be a traditional CNN architecture. The pruned sub-networks 406 represent the dynamic aspect of the network, where certain paths or layers may be activated or deactivated based on the input complexity and available computational resources.

FIG. 4(B) is a diagram 450 illustrating the utilization of computational resources for the dynamic neural network shown in FIG. 4(A). The horizontal axis measures the computational resources in floating-point operations per second (FLOPs), while the vertical axis represents the number of input samples processed at each complexity level.

As shown in FIG. 4(B), the computational load is non-uniform across different input samples in a dynamic network. Straightforward classification tasks, such as distinguishing between birds and dogs (represented by the images on the left side of the graph), consume minimal computational resources. These simpler tasks cluster towards the left side of the graph, indicating lower FLOPs usage.

Conversely, more intricate images, such as the detailed scenes or complex objects shown on the right side of the graph, necessitate substantial processing power. These complex tasks are represented by the bars on the right side of the graph, indicating higher FLOPs usage.

The graph in FIG. 4(B) demonstrates that out of a large dataset (e.g., 30,000 images), there may be a significant number of images (e.g., 3,000) that require as little as 1.3 gigaflops of processing power. This efficient allocation of resources is a key advantage of dynamic networks over static models, where each image may incur a fixed number of FLOPs regardless of its complexity.

The dynamic model's ability to adjust its computational load based on input complexity allows for a trade-off between accuracy and efficiency. This adaptability is particularly beneficial in environments with constrained resources, where the network can dynamically allocate more or fewer resources based on the current computational budget and the complexity of the input.

As neural networks continue to evolve, the hardware descriptors for accelerators such as a convolution engine 111, a vision process engine 120, or specialized DMA Engine 113 have become increasingly complex. These descriptors function as the interface between software and hardware, outlining the specific operations to be executed by the accelerators. The increased complexity of these descriptors has led to a corresponding increase in the CPU time required for drivers to fill them.

For example, while earlier DMA tasks primarily involved simple data copying operations, modern DMA hardware is capable of performing additional operations such as color conversion and other preprocessing tasks. To initiate these operations, a comprehensive descriptor needs to be provided, which serves as the hardware's instruction set. The process of filling these descriptors has become computationally intensive, requiring significant CPU time, especially as the complexity of the tasks increases.

This increase in descriptor complexity and the associated computational overhead presents a challenge in the context of dynamic neural networks. The need for frequent updates to these descriptors to accommodate the adaptive nature of dynamic networks can potentially offset some of the efficiency gains achieved through dynamic computation.

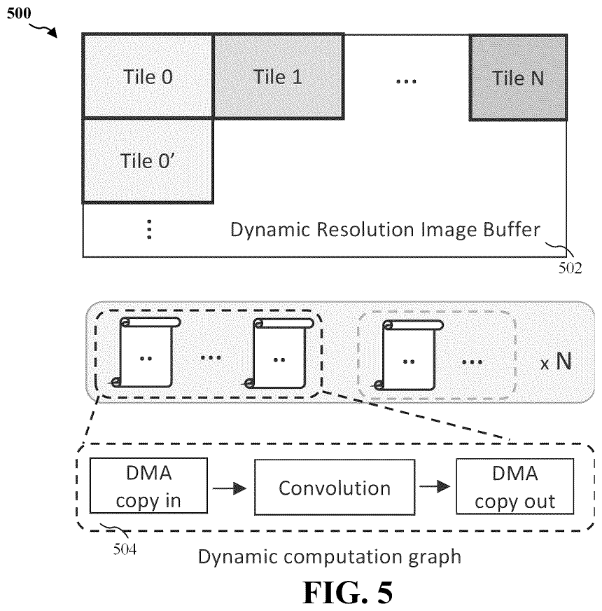

FIG. 5 is a diagram 500 illustrating the utilization of Direct Memory Access (DMA) in processing images with dynamic resolution. The diagram depicts a common approach for handling image data in tiles, particularly when utilizing Level 1(L1 ) or Level 2(L2 ) cache of the CPU. This tiling approach is used for efficient processing, given the limited size of L1 and L2 buffers.

In the dynamic computation graph 504 shown in FIG. 5, the DMA is employed to transfer data from a raw buffer into a work buffer of the L1 memory (referred to as “copy in”). The processing is then performed on one tile at a time within this work buffer. Following computation, the processed data is copied back to the original raw buffer (referred to as “copy out”).

An image 502 in FIG. 5 represents an input with dynamic resolution, which introduces challenges in the processing pipeline. The dynamic nature of the input resolution necessitates adaptive tiling strategies and flexible descriptor management.

When comparing static and dynamic graphs, differences emerge in how descriptors are handled at various stages. In a static graph, where the computational graph is predetermined and remains unchanging, the descriptors are filled during the compilation stage. This approach allows for efficient runtime execution, as the majority of the descriptor preparation is completed prior to actual execution. During runtime, the only adjustment required is updating the addresses of inputs and outputs, as these can vary depending on runtime conditions.

In dynamic graphs, however, the computational path through the network cannot be predetermined, as it must adapt based on runtime conditions and input characteristics. This dynamic nature means that descriptors cannot be prepared during compilation and must instead be generated on-demand by the controller 120 during runtime execution. This requirement to fill descriptors immediately at runtime introduces significant performance overhead, as the controller 120 must divert computational resources away from its primary task of dispatching and managing network operations. The need to dynamically generate and fill descriptors competes with the controller 120's role in orchestrating the overall execution flow, potentially creating bottlenecks that impact the network's runtime performance.

Dynamic networks exhibit a common phenomenon of repetitive descriptors. Similar tasks, such as 3×3 convolutions, often involve similar descriptors, with the primary variable being the addresses of the inputs and outputs. This repetition offers an opportunity for optimization by caching and reusing descriptors, potentially mitigating some of the controller overhead incurred during descriptor creation.

In one example, a DMA operation is tasked with copying data. The DMA hardware component may require a 64-byte descriptor to execute its function. This descriptor includes various fields that specify details pertaining to addresses and other operational aspects. For instance: 1. the first field is filled with the low-order bits of the source address; 2. the second field holds the low-order bits of the destination address; 3. additional fields are dedicated to store the high-order bits of both the source and destination addresses; and/or 4. beyond addressing information, the descriptor may also include details regarding padding, rotation, or any other specific operations required during the data copy process.

For example, if the descriptor pertains to a color conversion operation, specifically transforming three-dimensional RGB data into the four-dimensional RGBA format, the relevant configuration details may be included within the descriptor.

The below pseudocode illustrates the typical process of image processing using DMA:

```
L1_MEM work_buff;
/* Image resolution and tilling size can be dynamic */
for (raw_buff in image) {
    /* Fill descriptor and execute */
    /* Descriptor are repetitive */
    dma_copy(raw_buff, work_buff, in_args);
    compute (work_buff);
    dma_copy(work_buff, raw_buff, out_args);
}
```

This pseudocode demonstrates the iterative process of copying data from the raw buffer to the work buffer, performing computations, and then copying the results back to the raw buffer. Each iteration processes a single tile of the image.

However, tiles, particularly those located at the boundaries of the image, may pose challenges in terms of defining consistent starting points for DMA copy operations within the raw buffer. Furthermore, the size of the copy operations may not always align perfectly, especially when dealing with changes in resolution. This variability necessitates frequent updates to the DMA copy operation descriptors, which introduces additional controller overhead during runtime. Further, filling descriptors at runtime occupies valuable computation time of the controller, which can lead to performance bottlenecks, especially in time-sensitive applications.

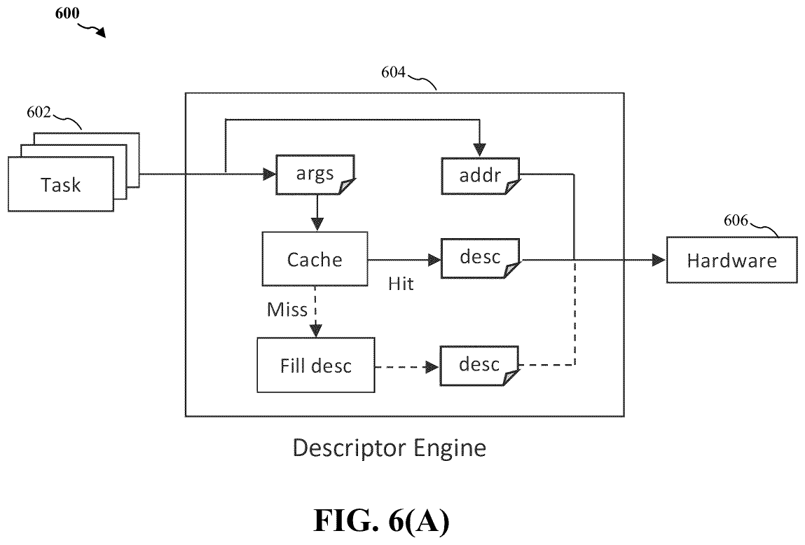

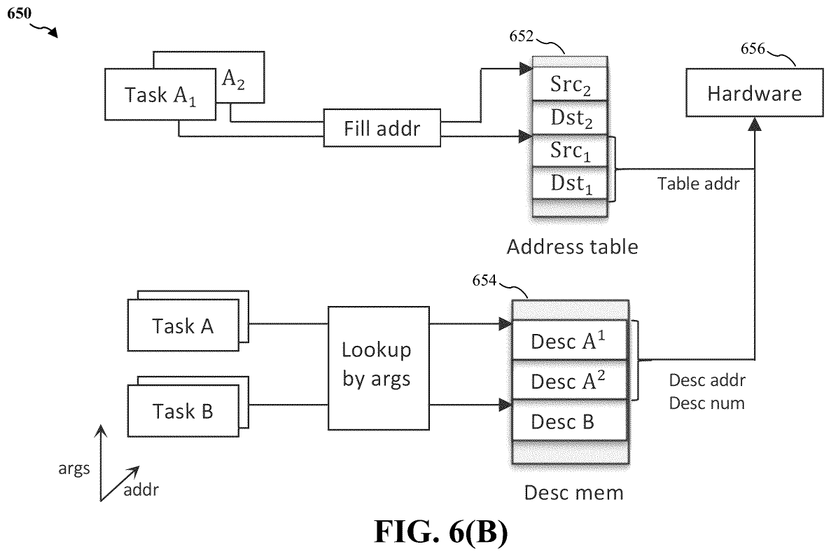

FIG. 6(A) is a diagram 600 illustrating a descriptor engine 604 that implements a mechanism for isolating arguments and addresses from tasks. This mechanism addresses the challenges posed by dynamic graphs in neural network processing, particularly in efficiently managing descriptors for various hardware components such as the DMA Engine 113, the convolution engine 111, and the vision processing engine 112.

The descriptor engine 604 is integrated in the controller 120. The primary function of this engine is to optimize the handling of tasks 602, which may include operations like DMA copy or convolution, by separating the task parameters into two distinct categories: arguments and addresses.

Arguments refer to the constant parameters that define the nature of the task, such as the dimensions of a convolution operation (e.g., 3×3 or 5×5). These arguments typically remain unchanged across similar tasks. Addresses, on the other hand, represent the memory locations where input data is read from and output data is written to. Unlike arguments, addresses frequently change between tasks, even when the tasks are of the same type.

When a new task 602 arrives at the descriptor engine 604, it undergoes a decomposition process. The engine extracts the arguments and addresses from the task, treating them as separate entities.

The descriptor engine 604 incorporates a cache system that stores frequently used descriptors. When the arguments of a task are extracted, they are first checked against this cache. If a matching entry is found in the cache (a cache hit), the corresponding descriptor is immediately retrieved. This process significantly reduces computation time of controller that may otherwise be spent on creating a new descriptor for each task. In the event that the arguments do not match any existing cache entry (a cache miss), the descriptor engine proceeds to create a new descriptor.

The descriptors stored in the cache and retrieved during a cache hit do not contain address information. This is an aspect of the address isolation mechanism. The descriptors only include the non-address related parameters of the task, which allows for their reuse across multiple tasks with different memory addresses.

The hardware 606, which may include components such as DMA units or convolution units, is designed to support this address isolation mechanism. When executing a task, the hardware 606 receives both the descriptor (containing the task arguments) and the separate address information. This design allows each task to utilize a different address table, providing flexibility in memory management.

To facilitate this process, the descriptor engine 604 maintains an address table. When a task is ready for execution, its corresponding addresses are loaded into this table. The hardware 606 has access to the correct memory locations for reading input data and writing output data.

This mechanism also supports scenarios where a single task may correspond to multiple descriptors. For example, a complex convolution operation may require multiple descriptors to fully define its behavior. The descriptor engine 604 is capable of handling such one-to-many mappings between tasks and descriptors.

FIG. 6(B) is a diagram 650 illustrating an example process for handling tasks in a dynamic neural network environment. This diagram expands upon the concepts introduced in FIG. 6(A), providing a more detailed view of how tasks, addresses, and descriptors are managed to optimize performance in dynamic computational graphs.

In this example, Task A1 and Task A2 represent 3×3 convolution operations that are identical in their computational requirements but differ in the memory locations they operate on. This scenario is common in tiled processing of images, where the same operation is applied to different portions of the input data. The address information for these tasks is stored in an address table 652, which includes source addresses (Src1 and Src2) and destination addresses (Dst1 and Dst2) for each task.

The address table 652 is used in the address isolation mechanism. By separating the address information from the task descriptors, the system can efficiently handle tasks that perform the same operation on different data locations. This separation allows for greater flexibility and reuse of descriptors, as the same descriptor can be applied to multiple tasks that differ only in their memory addresses.

Further, Task A and Task B represent convolution operations with different kernel sizes. For example, Task A may be a 3×3 convolution, while Task B may be a 5×5 convolution. These tasks have fundamentally different arguments and thus require different descriptors.

The system employs a lookup mechanism to find the appropriate descriptors for each task. This lookup is performed based on the task arguments, which are the non-address related parameters that define the operation. When a task is processed, its arguments are used to search the descriptor cache. If a matching descriptor is found (a cache hit), it is retrieved and placed in the descriptor memory 654.

In the case of Task A, which corresponds to two similar operations (A1 and A2), the same descriptor (Desc A) is retrieved twice and stored in the descriptor memory 654 as Desc A1 and Desc A2. This reuse of descriptors for similar tasks is an optimization in the system, reducing the need to generate new descriptors for each task and thereby saving computation time of the controller.

For Task B, which has different arguments, a separate descriptor (Desc B) is retrieved from the cache and stored in the descriptor memory 654.

The hardware 656 receives information from both the address table 652 and the descriptor memory 654 to execute the tasks. Instead of passing absolute addresses, the system provides offsets to the hardware 656. These offsets represent the relative positions of the addresses and descriptors within their respective memory spaces. This approach simplifies the interface between the software and hardware components, as the hardware can operate with a fixed base address and use the offsets to access the specific data and descriptor information required for each task.

By providing the hardware 656 with both the table address offset and the descriptor address offset, the system enables efficient access to the precise data locations and descriptor details needed for each task.

This mechanism supports dynamic neural networks by allowing for efficient handling of tasks with varying inputs and computational requirements. It enables a one-to-many mapping between tasks and descriptors, where multiple tasks with identical arguments can share a single cached descriptor. This approach enhances cache utilization and significantly reduces the time spent on descriptor filling during runtime.

The system's ability to isolate arguments and addresses from tasks, cache frequently used descriptors, and support address isolation in hardware addresses the challenges posed by dynamic computational graphs. It allows for efficient runtime descriptor filling, which is particularly important in scenarios where the network structure or parameters adapt based on input complexity or available computational resources.

Furthermore, this approach aligns with the features described in the invention disclosure. The isolation of arguments and addresses from tasks is clearly demonstrated in the separation of the address table 652 and the descriptor memory 654. The caching and lookup of frequently used descriptors based on arguments is illustrated in the process of retrieving descriptors for Task A and Task B. The hardware support for address isolation is evident in the use of separate offsets for the address table and descriptor memory, allowing each task to apply a different address table.

By caching and reusing descriptors, and by separating address information, the system reduces the computation time of the controller required for descriptor management. This is particularly beneficial in scenarios where the same or similar operations are performed repeatedly on different portions of the input data, as is common in image processing tasks.

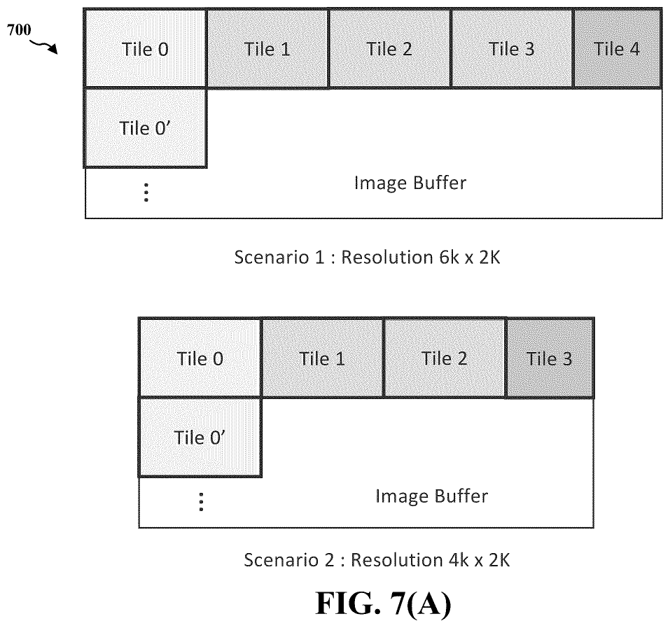

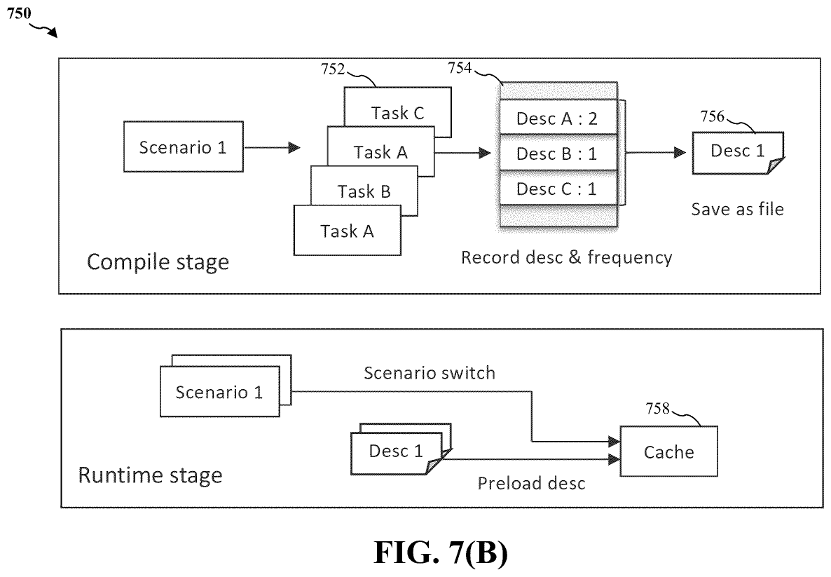

FIG. 7(A) is a diagram 700 illustrating two example scenarios for processing images with different resolutions in a dynamic neural network environment. This figure demonstrates how a cache warm-up mechanism can be implemented to optimize descriptor management and improve overall system performance.

Scenario 1 represents a high-resolution input with dimensions of 6K×2K. This scenario may be utilized in situations where high precision is required, such as detailed image analysis or advanced object recognition tasks. The image is divided into five tiles, each labeled with “tile”, indicating the system's approach to processing large images in manageable segments.

Scenario 2 illustrates a lower resolution input with dimensions of 4K×2K. This scenario may be employed in situations where processing speed takes precedence over ultra-high precision, such as real-time video analysis or rapid object detection. In this case, the image is divided into four tiles, reflecting the adapted tiling strategy for the different resolution.

The cache warm-up mechanism is designed to optimize the handling of these predictable scenarios by pre-loading frequently used descriptors into the cache. This approach addresses the challenge of maintaining high cache hit rates in dynamic neural networks, where the computational graph and required descriptors can vary based on input complexity and available resources.

The predictability of certain scenarios is utilized despite the overall dynamic nature of the network. By analyzing and recording the frequency of descriptor usage for each scenario during the compilation or training phase, the system can create a prioritized list of descriptors for each anticipated scenario.

For instance, in Scenario 1, the system may determine that a specific set of descriptors is commonly used for processing 6K×2K images. These may include descriptors for 3×3 convolutions, 5×5 convolutions, and various pooling operations, each with a recorded frequency of use. Similarly, for Scenario 2, a different set of descriptors may be identified as frequently used for the 4K×2K resolution.

When the system transitions between scenarios, such as switching from Scenario 2 to Scenario 1, the cache warm-up mechanism activates. It preloads the cache with the set of descriptors most frequently used in the new scenario. This preloading process occurs before the actual processing of the new input begins. As such, the most likely-to-be-used descriptors are readily available in the cache.

The mechanism may implement a Most Frequently Used (MFU) cache strategy, which can significantly increase the descriptor hit rate. By having the most relevant descriptors already in the cache, the system reduces the likelihood of cache misses, thereby minimizing the need for runtime descriptor generation.

Further, instead of starting with an empty cache and gradually filling it as operations are performed, the system can immediately populate the cache with relevant descriptors based on the initial scenario. This approach can lead to improved performance from the outset of system operation.

FIG. 7(B) is a diagram 750 illustrating a detailed process for scenario configuration and switching in a dynamic neural network environment. This process is designed to optimize descriptor management and improve overall system performance through efficient cache utilization.

In the compilation stage, the system analyzes and records descriptors associated with particular tasks within a given scenario. As an example, consider Scenario 1 depicted in FIG. 7(A), where the model processes high-resolution images of 6K×2K dimensions. At operation 752, the computational graph corresponding to this scenario is analyzed and categorized into different convolution operations. In this specific case, the analysis may reveal two instances of Task A for 3×3 convolutions, one instance of Task B for 5×5 convolutions, and one instance of Task C for 7×7 convolutions.

At operation 754, the system identifies the descriptors corresponding to these tasks and records the frequency of each descriptor's utilization. In this example, descriptor Desc A for Task A occurs twice, thus its frequency of “2” is recorded. Similarly, descriptor Desc B for Task B and descriptor Desc C for Task C each occur once, so their frequencies of “1” are recorded. This frequency information is for implementing the Most Frequently Used (MFU) cache policy described in the invention.

At operation 756, the system compiles the descriptors and their frequencies into a file or database, labeled as Desc 1. This compilation represents a comprehensive record of the descriptors most likely to be utilized in Scenario 1. The creation of such scenario-specific descriptor sets allows for efficient preloading of relevant descriptors when scenarios change.

In the runtime stage, when the model switches to a specific scenario, such as Scenario 1, the system activates its cache warm-up mechanism. At operation 758, the descriptors corresponding to Scenario 1 are preloaded into the cache from the file Desc 1. As such, the most relevant descriptors are readily available when needed, significantly increasing the cache hit rate.

Without this mechanism, a switch to a new scenario may result in a significant alteration of task parameters, leading to a different set of required descriptors. Consequently, the cache may experience numerous misses, as it may be incapable of immediately accommodating the new set of descriptors due to its limited capacity.

By employing this statistical approach to descriptor management, where frequently used descriptors in a particular scenario are identified and preloaded into the cache, the system effectively implements an MFU cache policy. To maximizes the likelihood of cache hits, the descriptors most relevant to the current scenario are readily accessible. Furthermore, the most relevant descriptors for each scenario are preloaded when that scenario is activated.

The cache warm-up mechanism described here works in conjunction with the argument and address isolation technique described supra. While the isolation technique optimizes the structure and retrieval of descriptors, the cache warm-up mechanism provides that the most relevant descriptors for each scenario are readily available in the cache.

The controller 120 including the history engine 170 from FIG. 1 may implement this cache warm-up mechanism. The history engine 170 may be responsible for recording and analyzing the frequency of descriptor usage in different scenarios during the compilation or training phase. This information may then be used by the controller 120 to manage the preloading of descriptors into the cache as scenarios change during runtime.

The cache memory 150, particularly the share buffer 152, may be utilized to store the scenario-specific descriptor sets. When a scenario change is detected, the controller 120 may quickly transfer the relevant descriptor set from the share buffer 152 to the active cache, minimizing the time required to prepare the system for the new computational context.

This mechanism can be further extended to adapt to long-term usage patterns. The system may continue to monitor and update the frequency of descriptor usage during runtime, allowing it to refine its preloading strategy over time. This adaptive approach may enable the system to optimize its performance for the specific usage patterns of individual deployments, further enhancing the efficiency of descriptor management in dynamic neural network environments.

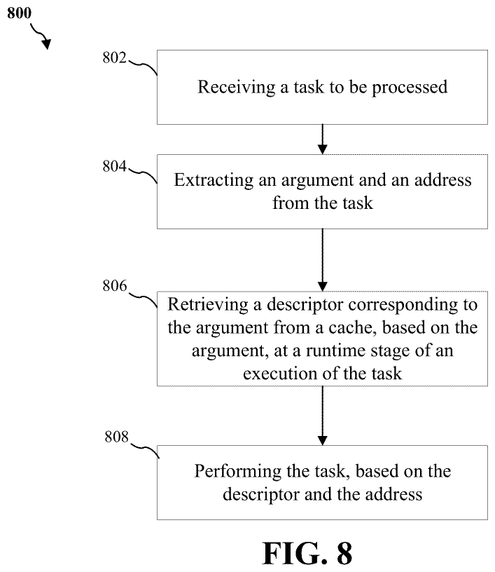

FIG. 8 illustrates a flow chart 800 of a process for runtime descriptor management. This process may be performed by a computing device.

At block 802, the computing device may receive a task to be processed. In some embodiments, the task may include an operation in a dynamic neural network. In some embodiments, the operation may include a convolution operation.

At block 804, the computing device may extract an argument and an address from the task.

At block 806, the computing device may retrieve a descriptor corresponding to the argument from a cache, based on the argument, at a runtime stage of an execution of the task. In some embodiments, the cache may include a Level 1(L1 ) cache or Level 2 (L2) cache of a compute unit of the computing device.

At block 808, the computing device may perform the task, based on the descriptor and the address. In some embodiments, the task may be performed by a driver of an accelerator of the computing device. In some embodiments, the accelerator may include an artificial intelligence (AI) processing unit (APU), a tensor processing unit (TPU), or a specialized direct memory access (DMA).

In some embodiments, the address may be stored in an address table, and the descriptor may be stored in a descriptor memory.

In some embodiments, the accelerator may fetch the address from the address table and the descriptor from the descriptor memory based on an address offset.

In some embodiments, multiple tasks with identical arguments may correspond to multiple retrieving of a shared descriptor.

In some embodiments, the retrieving may be performed by a descriptor engine of the computing device.

In some embodiments, the descriptor engine may be employed in a kernel space of the computing device.

In some embodiments, a particular descriptor associated with one of a plurality of scenarios may be stored in a database, each scenario including one or more tasks. The process may further include: in response to a scenario change, loading the particular descriptor into the cache from the database.

In some embodiments, the particular descriptor may be stored in the database at a compilation stage of the execution of the task.

In some embodiments, the plurality of scenarios may include processing images having different resolutions, each scenario corresponding to a resolution.

In some embodiments, the images may be processed in a tile-based manner.

In some embodiments, the computing device may include a phone, a tablet, an advanced driver assistance system (ADAS), or an extended reality (XR) device.

It is understood that the specific order or hierarchy of blocks in the processes / flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method executed by a computing device, comprising:
receiving a task to be processed;
extracting an argument and an address from the task;
retrieving a descriptor corresponding to the argument from a cache, based on the argument, at a runtime stage of an execution of the task; and
performing the task, based on the descriptor and the address.

2. The method of claim 1, wherein the cache comprises a Level 1(L1 ) cache or Level 2(L2 ) cache of a central processing unit (CPU) of the computing device.

3. The method of claim 1, wherein the task comprises an operation in a dynamic neural network.

4. The method of claim 3, wherein the operation comprises a convolution operation.

5. The method of claim 1, wherein the task is performed by a driver of an accelerator of the computing device.

6. The method of claim 5, wherein the accelerator comprises an artificial intelligence (AI) processing unit (APU), a tensor processing unit (TPU), or a specialized direct memory access (DMA).

7. The method of claim 6, wherein the address is stored in an address table, and the descriptor is stored in a descriptor memory.

8. The method of claim 7, wherein the accelerator fetches the address from the address table and the descriptor from the descriptor memory based on an address offset.

9. The method of claim 1, wherein multiple tasks with identical arguments correspond to multiple retrieving of a shared descriptor.

10. The method of claim 1, wherein the retrieving is performed by a descriptor engine of the computing device.

11. The method of claim 10, wherein the descriptor engine is employed in a kernel space of the computing device.

12. The method of claim 1, wherein a particular descriptor associated with one of a plurality of scenarios is stored in a database, each scenario comprising one or more tasks; and
the method further comprises:
in response to a scenario change, loading the particular descriptor into the cache from the database.

13. The method of claim 12, wherein the particular descriptor is stored in the database at a compilation stage of the execution of the task.

14. The method of claim 12, wherein the plurality of scenarios comprise processing images having different resolutions, each scenario corresponding to a resolution.

15. The method of claim 14, wherein the images are processed in a tile-based manner.

16. The method of claim 1, wherein the computing device comprises a phone, a tablet, an advanced driver assistance system (ADAS), or an extended reality (XR) device.

17. A computing device, comprising:
a memory; and
at least one processor coupled to the memory and configured to:
receive a task to be processed;
extract an argument and an address from the task;
retrieve a descriptor corresponding to the argument from a cache, based on the argument, at a runtime stage of an execution of the task; and
perform the task, based on the descriptor and the address.

18. The computing device of claim 17, wherein the cache comprises a Level 1(L1 ) cache or Level 2(L2 ) cache of a central processing unit (CPU) of the computing device.

19. The computing device of claim 17, wherein the task comprises an operation in a dynamic neural network.

20. A computer-readable medium storing computer executable code, comprising code to:
receive a task to be processed;
extract an argument and an address from the task;
retrieve a descriptor corresponding to the argument from a cache, based on the argument, at a runtime stage of an execution of the task; and
perform the task, based on the descriptor and the address.
